(19) United States
(12) Patent Application Publication
(10) Pub. No.: US 2009/0109124 A1
(43) Pub. Date: Apr. 30, 2009

(54) IMAGE PROCESSING METHOD AND SYSTEM

(75) Inventor: Sang Wook HAN, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/190,330

(22) Filed: Aug. 12, 2008

(30) Foreign Application Priority Data
Oct. 29, 2007 (KR) 2007-0108841

(51) Int. Cl. G09G 5/00

(52) U.S. Cl. 345/1.3

(57) ABSTRACT

An image processing method and system are provided. The system includes a master communication terminal for assigning a master displaying region and one or more slave displaying regions of an image when displaying the image, for splitting the image into the master displaying region and the slave displaying regions, and for displaying the master displaying region, and at least one slave communication terminal for displaying any one of the slave displaying regions when the master communication terminal displays the master displaying region. A plurality of communication terminals can display an image with an enlarged size greater than the image displayed by a single communication terminal.

### PRIORITY

This application claims the benefit under 35 U.S.C. § 119(a) of a Korean patent application filed in the Korean Intellectual Property Office on Oct. 29, 2007 and assigned Serial No. 2007-0108841, the entire disclosure of which is hereby incorporated by reference.

### BACKGROUND OF THE INVENTION

1. Field of the Invention

The present invention relates to a data processing method and system. More particularly, the present invention relates to image processing method and system for displaying an image.

2. Description of the Related Art

In general, a communication terminal is evolving into a multi-purpose communication terminal. A conventional communication terminal includes a camera function, a digital broadcast receiving function, and a message transmitting and receiving function to perform various multi-media functions. Due to this, the communication terminal provides various displaying screens corresponding to the respective multi-media functions. The communication terminal can provide a display screen in a form of a two-dimensional image or a three-dimensional image.

A size of the three-dimensional image displayed in the communication terminal is limited by a size of a Liquid Crystal Display (LCD). For this reason, the communication terminal must correctly display respective regions of the three-dimensional image in order to display the entire three-dimensional image. Thus, it would not be easy for a user of the communication terminal to perceive the entire three-dimensional image. This problem may become more serious as the communication terminal becomes smaller.

Therefore, a need exists for an improved system and method for processing images in the communication terminal.

### SUMMARY OF THE INVENTION

An aspect of the present invention is to address the above-mentioned problems and/or disadvantages and to provide at least the advantages described below. Accordingly, an aspect of the present invention is to provide a system and method for processing images.

In accordance with an aspect of the present invention, an image processing method comprising a master communication terminal and at least one slave communication terminal is provided. The method includes splitting, by the master communication terminal, a three-dimensional image into a master displaying region and at least one slave displaying region, transmitting, by the master communication terminal, the respective slave displaying regions to the respective slave communication terminals, and displaying the master displaying region and the slave displaying regions by the master communication terminal and the slave communication terminals at the same time point.

In accordance with another aspect of the present invention, an image processing method comprising a master communication terminal and at least one slave communication terminal is provided. The image processing method includes assigning, by the master communication terminal, a portion of a master displaying region and at least one slave displaying region of the three-dimensional image when displaying the three-dimensional image, and transmitting the portion of the respective slave displaying regions to the respective slave communication terminals by the master communication terminal, splitting the three-dimensional image into the master displaying region and the slave displaying regions by the master communication terminal and the slave communication terminals, expanding, by the master communication terminal, the portion of the master displaying region by a preset multiple, and expanding, by the respective slave communication terminals, the transmitted portion of the slave displaying regions by the preset multiple, and displaying the master displaying region and the slave displaying regions by the master communication terminal and the slave communication terminals at the same time point.

In accordance with another aspect of the present invention, an image processing system is provided. The system includes a master communication terminal for assigning a master displaying region and at least one slave displaying region of a three-dimensional image when displaying the three-dimensional image, for splitting the three-dimensional image into the master displaying region and the slave displaying regions, and for displaying the master displaying region, and at least one slave communication terminal for displaying any one of the slave displaying regions when the master communication terminal displays the master displaying region.

Therefore, according to the image processing method and system, a plurality of communication terminals can display a three-dimensional image with an enlarged size greater than that displayed by a single communication terminal. Due to this, a user of the communication terminal can easily perceive the overall regions of the three-dimensional image. Moreover, the user of the communication terminal can perceive a function executed between the communication terminals by viewing the displayed three-dimensional image.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a schematic configuration of an image processing system according to an exemplary embodiment of the present invention;

FIGS. 2A to 2C illustrate a schematic configuration of an image processing system according to an exemplary embodiment of the present invention;

FIG. 3 is a flowchart illustrating an image processing procedure according to an exemplary embodiment of the present invention;

FIG. 4 is a flowchart illustrating an image processing procedure according to an exemplary embodiment of the present invention;

FIG. 5 is a schematic block diagram illustrating a configuration of an image processing system according to an exemplary embodiment of the present invention;

FIG. 6 is a flowchart illustrating an image processing procedure according to an exemplary embodiment of the present invention;

FIG. 7 is a flowchart illustrating an image displaying procedure of a communication terminal according to an exemplary embodiment of the present invention; and

FIG. 8 is a flowchart illustrating an image display procedure of a communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In the following description, the term “image” refers to visual information displayed in a communication terminal. The image includes a still image and a moving image. The image may be a function-executing screen such as an image of a digital broadcast, a photograph, a data transmission screen, and the like. The term “two-dimensional image” refers to a plane image. The term “three-dimensional image” refers to a solid image displayed in a space. The term “master communication terminal” refers to a communication terminal for controlling another communication terminal to lead an image processing of dividing and displaying a single image. The term “slave communication terminal” refers to a communication terminal controlled by the master communication terminal to split and display the single image. The term “master displaying region” refers to one of at least two regions of a single image to be displayed by the master communication terminal. The term “slave displaying region” refers to the other of the at least two regions of the single image to be displayed by the slave communication terminal. Respective slave communication terminals display corresponding slave display regions corresponding to a preset portion of the image under the control of the master communication terminal.

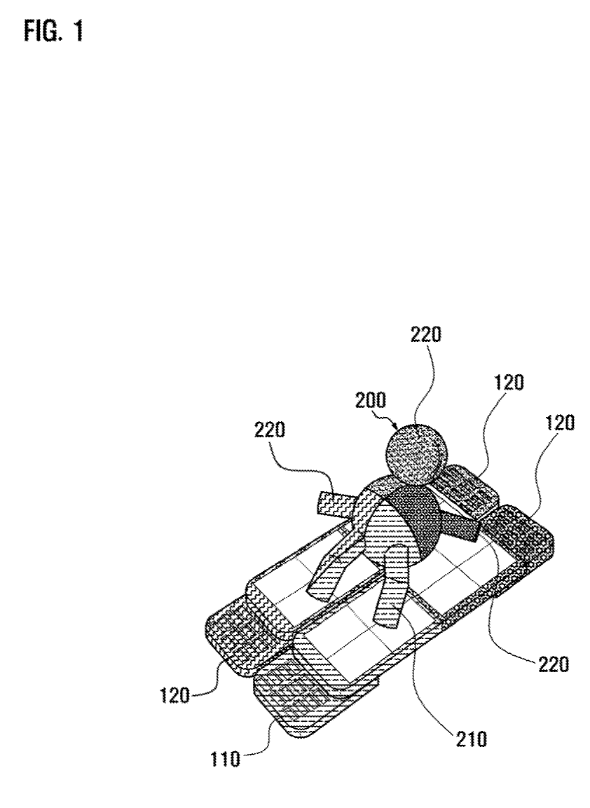

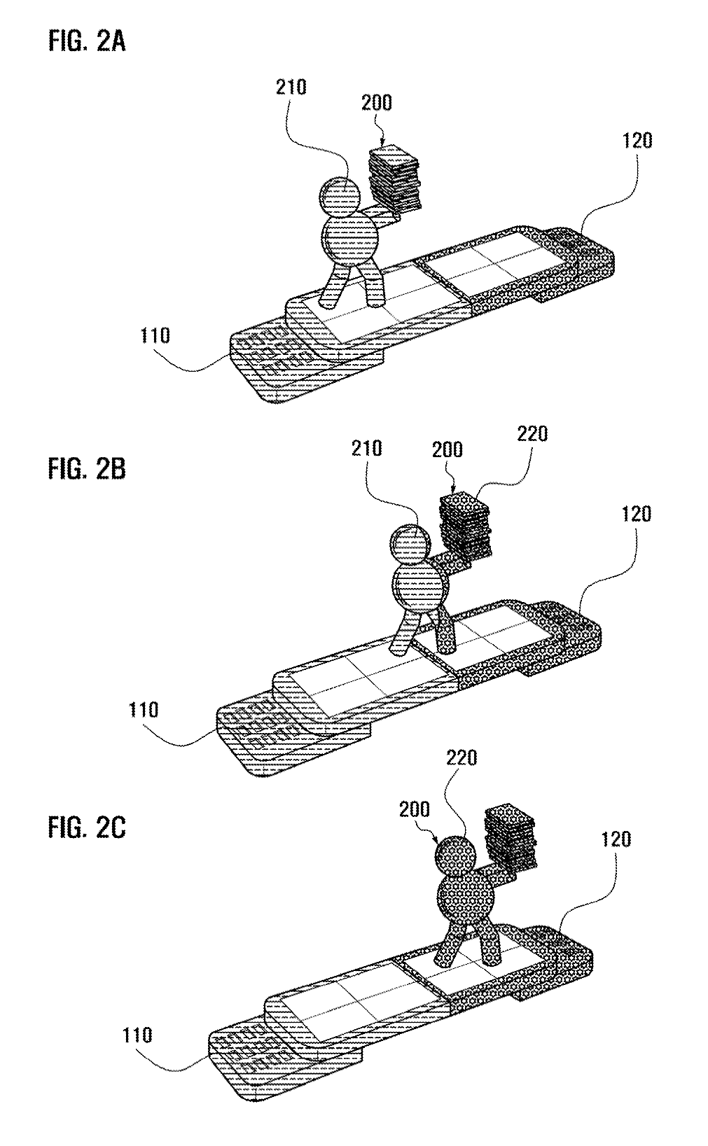

FIG. 1 illustrates a schematic configuration of an image processing system according to an exemplary embodiment of the present invention and an example of an image. FIGS. 2A to 2C illustrate a schematic configuration of an image processing system according to another exemplary embodiment of the present invention and an example of an image. FIGS. 1 and 2A to 2C illustrate cases when the images to be displayed are three-dimensional images. FIG. 1 illustrates a case when a general image is displayed and FIGS. 2A to 2C illustrate a case when an image is a data processing screen.

Referring to FIGS. 1 and 2A to 2C, an image processing system includes two communication terminals 110 and 120. One of the communication terminals 110 and 120 becomes a master communication terminal 110 and the other becomes a slave communication terminal 120. The master communication terminal 110 and the respective slave communication terminals 120 are interconnected through a short range communication such as Bluetooth. Each of the respective communication terminals 110 and 120 displays one of at least two displaying regions 210 and 220, which are split from a single image 200 at the same point in time and expanded by a preset multiple. In this case, the master communication terminal 110 displays a master displaying region 210 of the single image 200 expanded by a preset multiple, and the slave communication terminals 120 display slave displaying regions 220 of the single image 200, which are expanded by a preset multiple. The preset multiple corresponds to the number of the displaying regions 210 and 220. In an exemplary implementation, an image processing system may include four communication terminals 110 and 120. In this case, a master communication terminal 110 displays a master displaying region 210 expanded by four times, and respective slave communication terminals 120 display slave displaying regions 220, expanded by four times and corresponding to the respective slave communication terminals 120.

Thus, users of the communication terminals 110 and 120 can acquire an image 200 with an enlarged size greater than the image displayed by respective single communication terminals 110 and 120. Moreover, the users of the communication terminals 110 and 120 may perceive a function executed in association between the communication terminals 110 and 120 from the image 200.

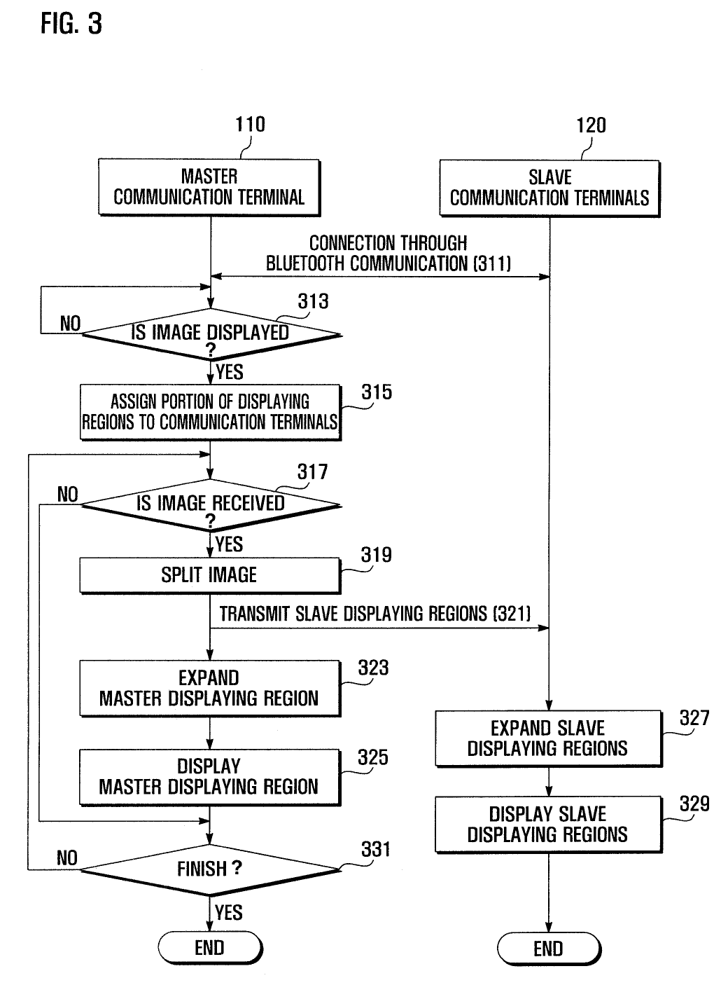

FIG. 3 is a flowchart illustrating an image processing procedure according to an exemplary embodiment of the present invention. The exemplary embodiment will be described by assuming an image as an image of a digital broadcast.

Referring to FIG. 3, the image processing procedure according to this exemplary embodiment of the present invention starts with the master communication terminal 110 and the slave communication terminals 120 being interconnected through a Peer-to-Peer (P2P) connection, such as Bluetooth communication in step 311. When a request for displaying the image 200 is input, the master communication terminal 110 detects the request in step 313 and a portion of the displaying regions is assigned to the respective communication terminals 110 and 120 in step 315. In other words, the master communication terminal 110 assigns one of at least two regions of the image 200 to the master displaying region 210. The master communication terminal 110 assigns the rest of the at least two regions to slave displaying regions 220 to be displayed by the slave communication terminals 120 according to the portion to be assigned.

When the image 200 is received, the master communication terminal 110 detects the receipt of the image 200 in step 317 and splits the image 200 in step 319. In this case, the master communication terminal 110 splits the image 200 into the master displaying region 210 and the slave displaying regions 220. The master communication terminal 110 may receive an image displaying time point for displaying the image 200 when the image 200 is received. The master communication terminal 110 transmits the slave displaying regions 220 in step 321. In other words, the master communication terminal 110 transmits the slave displaying regions 220 to the respective slave communication terminals 120. In this case, the master communication terminal 110 may transmit the image displaying time point to the respective slave communication terminals 120.

Continuously, the master communication terminal 110 expands the master displaying region 210 by a preset multiple in step 323. In this case, the master communication terminal 110 expands the master displaying region 210 by a multiple corresponding to a sum of the numbers of the master displaying region 210 and the slave displaying regions 220. The multiple may be calculated and registered in advance. After that, the master communication terminal 110 displays the master displaying region 210 at the image displaying time point in step 325.

Meanwhile, when the slave displaying regions 220 are received, the slave communication terminals 120 expand the slave displaying regions 220 by a preset multiple in step 327. In this case, each of the slave communication terminals 120 expands the slave displaying region 220 by a multiple corresponding to a sum of the numbers of the master displaying region 210 and the slave displaying regions 220. The multiple may be received from the master communication terminal 110 and be registered in advance. After that, the slave communication terminals 120 display the corresponding slave displaying regions 220 at the image displaying time point in step 329.

Thus, the master communication terminal 110 and the slave communication terminals 120 display the master displaying region 210 and the slave displaying regions 220 at the same image displaying time point, respectively. Users of the communication terminals 110 and 220 can acquire an image 200 expanded by the preset multiple by combining the master displaying region 210 with the slave displaying regions 220.

Finally, when there is a request for finishing the image processing procedure, the master communication terminal 110 detects the request in step 331 and finishes the image processing procedure. When there is not a request for finishing the image processing procedure, the master communication terminal 110 and the slave communication terminals 120 perform the steps 317 to 331 again. Thus, users of the communication terminals 110 and 120 can continuously acquire the expanded image 200.

Although the case wherein the slave communication terminals expand the slave displaying regions by a preset multiple when the slave displaying regions are received from the master communication terminal has been described in an exemplary embodiment of the present invention, the present invention is not limited thereto. The master communication terminal may expand the master displaying region and the slave displaying regions by a preset multiple to transmit the displaying regions to the respective slave communication terminals. The master communication terminal and the respective slave communication terminals display the master displaying region and the slave displaying regions at the same time point so that an exemplary embodiment of the present invention can be implemented.

Although this exemplary embodiment has been described by assuming the image is an image of a digital broadcast, the present invention is not limited to this. For example, the image may be an image stored in the master communication terminal in advance. In this case, the present invention can be implemented even when the master communication terminal does not receive the image. The master communication terminal may transmit a certain image displaying time point to the slave communication terminals. Furthermore, although the exemplary embodiment has been described with an example in which the master communication terminal and the slave communication terminals are interconnected through Bluetooth communication, the present invention is not limited to this. In other words, the master communication terminal and the slave communication terminals may be interconnected through a short range communication other than Bluetooth communication to implement an exemplary embodiment of the present invention.

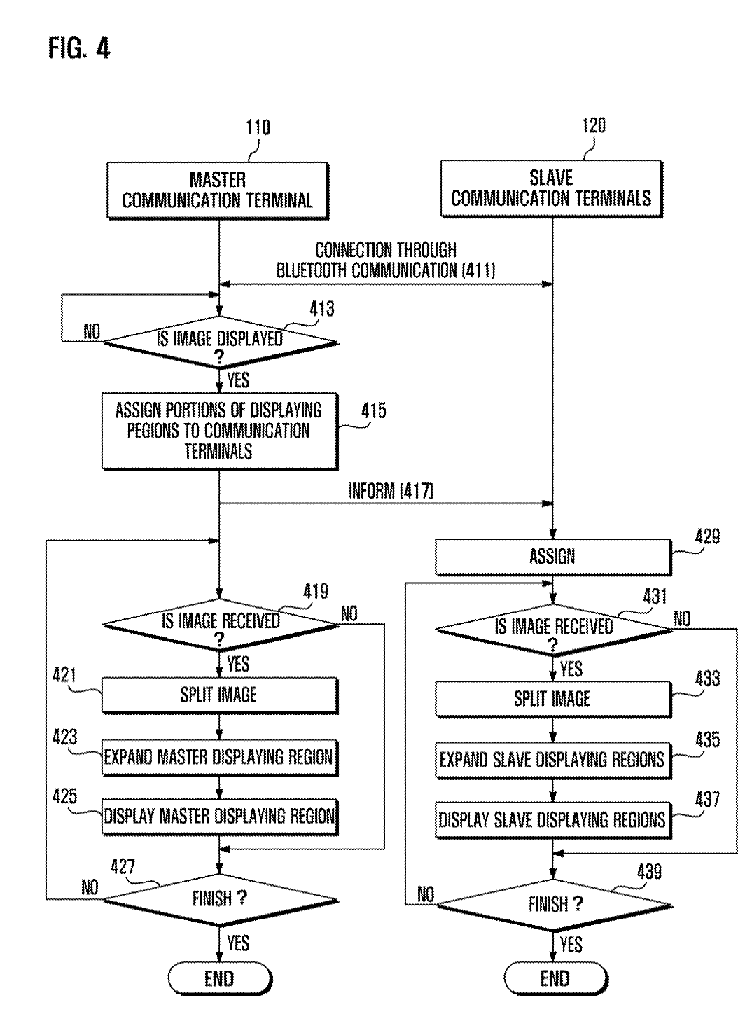

FIG. 4 is a flowchart illustrating an image processing procedure according to an exemplary embodiment of the present invention. In this exemplary embodiment, the image processing procedure will be described by assuming the image as an image of a digital broadcast.

Referring to FIG. 4, since steps 411, 413 and 415 are similar to steps 311, 313 and 315 in the image processing procedure of FIG. 3, their description will be omitted.

In this exemplary embodiment, the master communication terminal 110 informs an assigned portion of the image displaying regions to the respective slave communication terminals 120 in step 417. After that, when the image 200 is received, the master communication terminal 110 detects the receipt in step 419, and splits the image 200 in step 421. In this case, the master communication terminal 110 splits the image 200 into the master displaying region 210 and the slave displaying regions 220. When the image 200 is received, the master communication terminal 110 may receive an image displaying time point of displaying the corresponding image 200. The master communication terminal 110 expands the master displaying region 210 by a preset multiple in step 423. In this case, the master communication terminal 110 expands the master displaying region 210 by a multiple corresponding to a sum of the numbers of the master displaying region 210 and the slave displaying regions 220. The multiple may be calculated and registered in advance. After that, the master communication terminal 110 displays the master displaying region 210 at the image displaying time point in step 425.

When there is a request for finishing the image processing procedure, the master communication terminal 110 detects the request in step 427 and finishes the image processing procedure. When there is no request for finishing the image processing procedure, the master communication terminal 110 returns to step 419.

When the assigned portion of the image displaying regions are received from the master communication terminal 110, the slave communication terminals 120 are set to display the assigned slave displaying regions 220 of the at least two regions of the image 200 in step 429. After that, when the image 200 is received, the slave communication terminals 120 detect the receipt of the image 200 in step 431 and split the image 200 in step 433. The slave communication terminals 120 split the image 200 into the master displaying region 210 and the slave displaying regions 200. The slave communication terminals 120 may receive the image displaying time point of displaying the corresponding image 200 when the image 200 is received. The slave communication terminals 120 expand the assigned portion of the slave displaying regions 220 by a preset multiple in step 435. In this case, the slave communication terminals 120 expand the slave displaying regions 220 by a multiple corresponding to a sum of the numbers of the master displaying region 210 and the slave displaying regions 220. The multiple may be received from the master communication terminal 110 and may be registered in advance. After that, the slave communication terminals 120 display the slave displaying regions 220 assigned to the image displaying time point when the master communication terminal 110 displays the master displaying region 210 in step 437.

Next, when there is a request for finishing the image processing procedure, the slave communication terminals 120 detect the request and finish the image processing procedure in step 439. When there is no request for finishing the image processing procedure, the slave communication terminals 120 returns to step 431.

Thus, the master communication terminal 110 and the slave communication terminals 120 display the master displaying region 210 and the slave displaying regions 220 at the same image displaying time point, respectively. Users of the communication terminals 110 and 120 combine the master displaying region 210 with the slave displaying regions 220 to display the expanded image 200. Moreover, users of the communication terminals 110 and 120 can display the expanded image 200 until the image processing procedure is finished.

Although this exemplary embodiment has been described by assuming the image is an image of a digital broadcast, the present invention is not limited to this. For example, the image may be an image stored in the master communication terminal in advance. In this case, an exemplary implementation of the present invention can be configured even when the master communication terminal does not receive the image. In other words, the master communication terminal may transmit an image to the slave communication terminals before dividing the image. The master communication terminal may transmit a certain image displaying time point to the slave communication terminals. Furthermore, although the exemplary embodiment has been described with an example in which the master communication terminal and the slave communication terminals are interconnected through Bluetooth communication, the exemplary embodiment is not limited to this. In other words, the master communication terminal and the slave communication terminals may be interconnected through a short range communication other than Bluetooth communication to implement an exemplary embodiment of the present invention, such as an Infrared Data Association (IrDA) communication and the like.

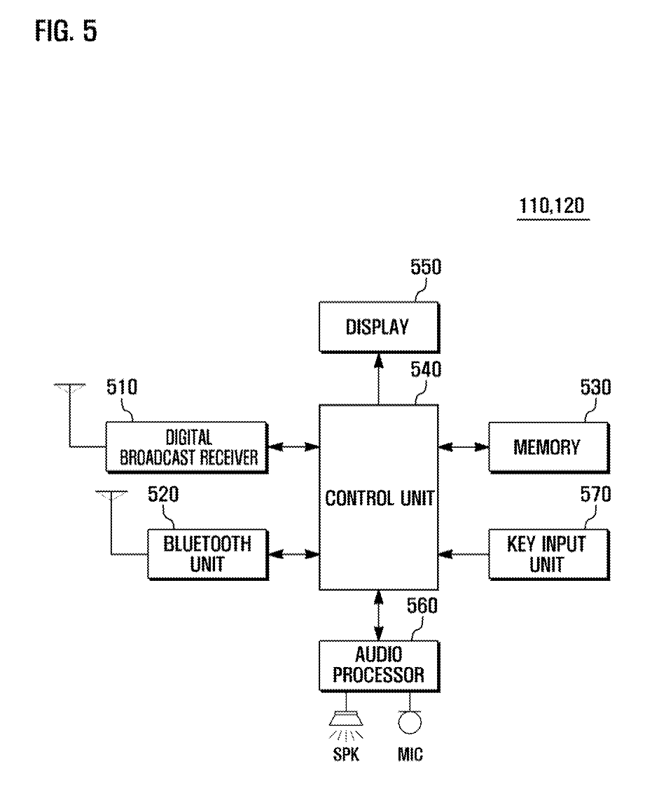

FIG. 5 is a schematic block diagram illustrating a configuration of an image processing system according to an exemplary embodiment of the present invention.

Referring to FIG. 5, each of communication terminals 110 and 120 of an image processing system may include a digital broadcast receiver 510, a Bluetooth unit 520, a memory 530, a control unit 540, a display 550, an audio processor 560, and a key input unit 570.

The digital broadcast receiver 510 performs a function of receiving a digital broadcast. The digital broadcast receiver 510 receives the digital broadcast corresponding to a channel selected by users of the communication terminals 110 and 120. In this case, the digital broadcast receiver 510 may receive the digital broadcast in the form of a two-dimensional image or a three-dimensional image.

The Bluetooth unit 520 performs Bluetooth communication of the communication terminals 110 and 120. To this end, the Bluetooth unit 520 controls hardware and software corresponding to a Bluetooth protocol. In another exemplary embodiment of the present invention, Bluetooth unit 520 may be any other type of short range or P2P communication unit for performing communication of the master communication terminal and the one or more slave communication terminals.

The memory 530 may include a program memory and a data memory. The program memory stores programs for controlling general operations of the communication terminals 110 and 120. The program memory may store programs for processing an image according to the exemplary embodiment of the present invention. The date memory performs a function of storing data created during the performance of programs.

The control unit 540 controls the overall operations of the communication terminals 110 and 120. The control unit 540 includes a data processor having a transmitter (not shown) for encoding and modulating a signal to be transmitted and a receiver (not shown) for demodulating and decoding a signal to be received. The data processor may be a MODEM and a CODEC. The CODEC includes a data CODEC for processing packet data and an audio CODEC for processing an audio signal such as voice.

A control unit 540 of the master communication terminal 110 works as follows. The control unit 540 assigns a portion of the master displaying region 210 and at least one slave displaying region 220 of the image 200 in this exemplary embodiment. In this case, the control unit 540 may inform the portion assigned to the slave displaying regions to the respective slave communication terminals 120. The control unit 540 splits the image 200 into a master displaying region 210 and at least one slave displaying region 220 when displaying the image 200. The control unit 540 may transmit the respective slave displaying regions to the corresponding slave communication terminals 120. In this case, the control unit 540 may transmit the slave displaying regions 220 by expanding by a preset multiple or without expansion. The control unit 540 controls the master displaying region 210 to be expanded by a preset multiple and to be displayed.

The control units 540 of the slave communication terminals 120 work as follows. Each of the control units 540 may be assigned to display an assigned portion of the slave displaying region 220 when receiving the assigned portion of the slave displaying region 220. Each of the control units 540 may split the image 200 into the master displaying region 210 and at least one slave displaying region 220 when receiving the image 200. Each of the control units 540 may expand the assigned portion of the slave displaying region 220 by a preset multiple to display. Otherwise, each of the control units 540 may expand the assigned portion of the slave displaying region 220 by a preset multiple to display when receiving the slave displaying region 220. Alternately, each of the control units 540 may display the slave displaying region 220 when receiving the slave displaying region 220 expanded by a preset multiple.

Each of the displays 550 displays a user data output from each of the control units 540. Each of the displays 550 may selectively display a two-dimensional image or a three-dimensional image. In other words, the displays 550 are Liquid Crystal Display (LCD) or Organic Light-Emitting Diode (OLED) displays for displaying the image such that a user can watch different screens due to a viewing angle difference between the eyes (left eye and right eye) even without special eye glasses.

Each of the audio processors 560 reproduces a receiving audio signal output from the audio CODEC of the data processor through a speaker (SPK) and transmits a transmitting audio signal generated through a microphone (MIC) to the audio CODEC of the data processor.

Each of the key input units 570 includes function keys for executing various functions. Each of the key input units 570 may include a key for driving the Bluetooth unit 520 or the digital broadcast receiver 510.

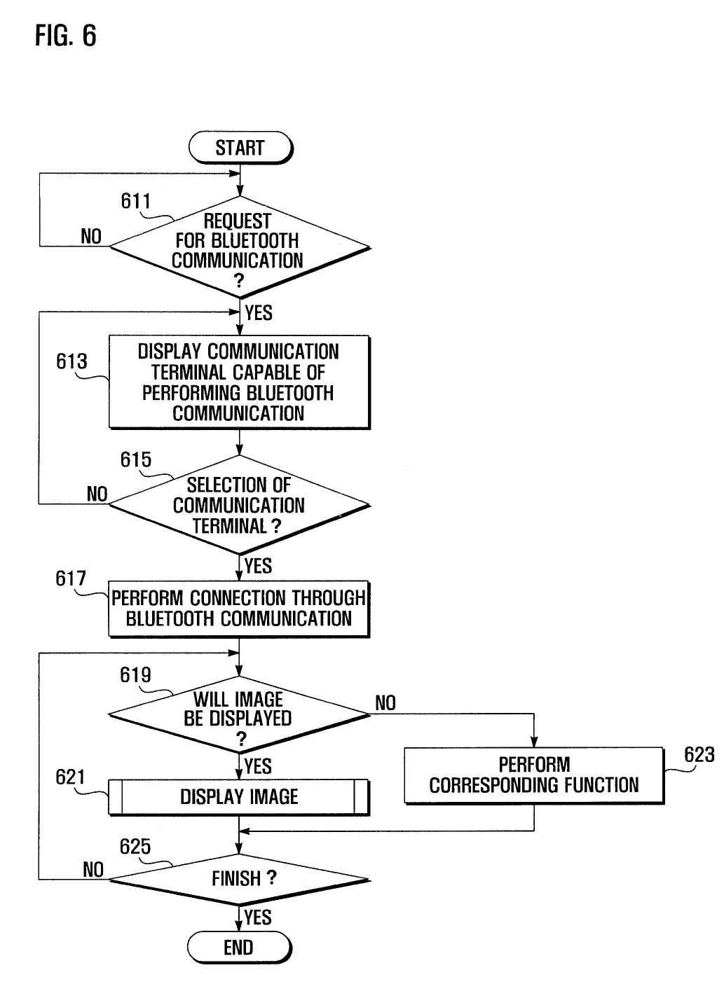

FIG. 6 is a flowchart illustrating an image processing procedure according to an exemplary embodiment of the present invention. The image processing procedure of the master communication terminal will be described in this exemplary embodiment.

Referring to FIG. 6, an image processing procedure according to this exemplary embodiment of the present invention starts when a control unit 540 detects a request for performing Bluetooth communication in step 611. After that, the control unit 540 displays information on a communication terminal capable of performing the Bluetooth communication in step 613. For example, the control unit 540 may display information on a pair of communication terminals. When a slave communication terminal 120 is selected, the control unit 540 detects the selection in step 615, and performs a connection with the selected slave communication terminal 120 for the Bluetooth communication in step 617. In this case, the control unit 540 may perform the connection with a plurality of slave communication terminals 120 for the Bluetooth communication according to the number of selectable slave communication terminals 120.

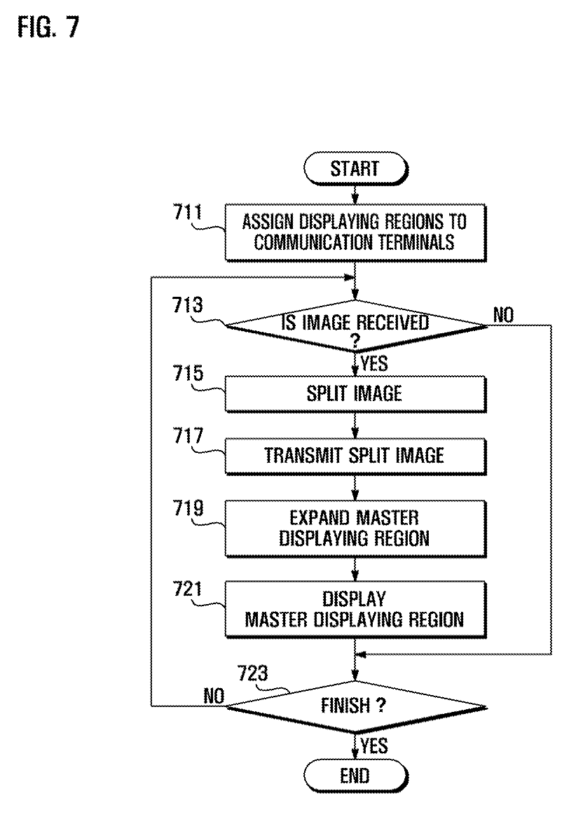

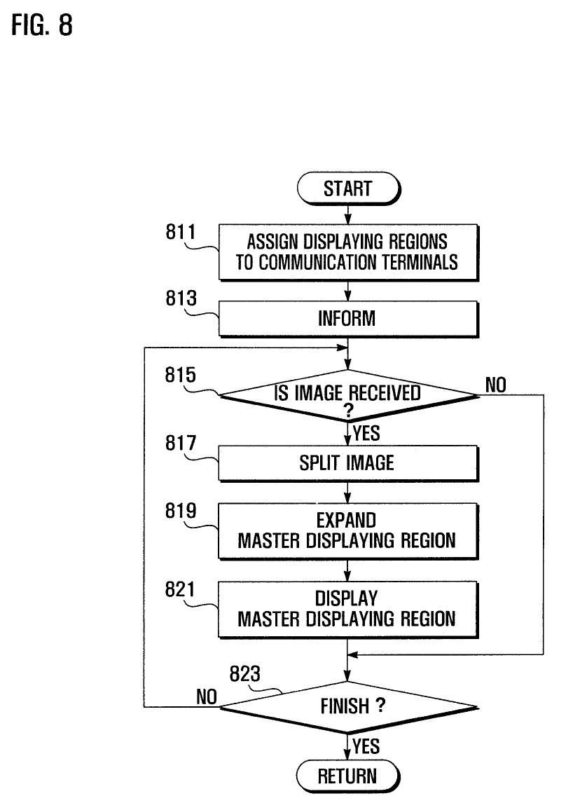

The control unit 540 determines whether an image 200 would be displayed in step 619. When the image 200 is determined to be displayed, the control unit 540 performs a procedure of displaying the image 200 in step 621. The control unit 540 controls the respective interconnected slave communication terminals 120 to display the expanded image 200. As such, the procedure of the control unit 540 for displaying the image 200 will be described with reference to FIGS. 7 and 8 as follows. In this case, it is assumed that the image is an image of a digital broadcast.

FIG. 7 is a flowchart illustrating an image displaying procedure of a communication terminal according to the exemplary embodiment of the present invention.

Referring to FIG. 7, the control unit 540 assigns the image displaying regions to the communication terminals 110 and 120 in step 711. In other words, the control unit 540 determines a portion of the master displaying region 210 of the image 200 and determines the portion of the slave displaying regions 220 displayed by the respective slave communication terminals 120. After that, when receiving the image 200, the control unit 540 detects the receipt of the image 200 in step 713 and splits the image 200 in step 715. In other words, the control unit 540 splits the image 200 into the master displaying region 210 and the slave displaying regions 220. In this case, the control unit 540 may receive the image 200 and the image displaying time point when the image is displayed. The control unit 540 transmits the slave displaying regions 220 to the respective slave communication terminals 120 in step 717. The control unit 540 also transmits the image displaying time point to the slave communication terminals 120.

The control unit 540 expands the master displaying region 120 by a preset multiple in step 719. In other words, the control unit 540 expands the master displaying region 210 by a multiple corresponding to a sum of the numbers of the master displaying region 210 and the slave displaying regions 220. The control unit 540 displays the master displaying region 210 at the image displaying time point in step 721. When there is a request for finishing the image displaying procedure, the control unit 540 detects the request in step 723, finishes the image displaying procedure, and returns to the procedure of FIG. 6. When there is no request for finishing the image displaying procedure, the control unit 540 returns to step 713.

Although the case where the control unit transmits unexpanded slave displaying regions has been described, the present invention is not limited thereto. In other words, this embodiment may be implemented such that the control unit expands the master displaying region and the slave displaying regions by a preset multiple to transmit the expanded regions to the respective slave communication terminals.

FIG. 8 is a flowchart illustrating an image display procedure of a communication terminal according to an exemplary embodiment of the present invention.

Referring to FIG. 8, the control unit 540 assigns a portion of the image displaying regions to the communication terminals 110 and 120. In other words, the control unit 540 determines a portion of the master displaying region 210 of the image 200, and a portion of the slave displaying regions 220 to be displayed by the respective slave communication terminals 120. The control unit 540 informs the portion assigned to the slave displaying regions to the respective slave communication terminals 120 in step 813. The control unit 540 detects the information when receiving the image 200 in step 815 and splits the image 200 in step 817. In other words, the control unit 540 splits the image 200 into the master displaying region 210 and the slave displaying regions 220. In this case, the control unit 540 may receive the image 200 and an image displaying time point of displaying the image 200.

The control unit 540 expands the master displaying region 210 by a preset multiple in step 819. In other words, the control unit 540 expands the master displaying region 210 by a multiple corresponding to a sum of the numbers of the master displaying region 210 and the slave displaying regions 220. The control unit 540 displays the master displaying region 210 at the image displaying time point in step 821. After that, when there is a request for finishing the image displaying procedure, the control unit 540 detects the request in step 823, finishes the image displaying procedure, and returns to the procedure of FIG. 6. When there is no request for finishing the image displaying procedure, the control unit 540 returns to step 815.

Although the above-mentioned exemplary embodiments of the present invention have been described by assuming the image is an image of a digital broadcast, the present invention are not limited thereto. For example, the image may be an image stored in the master communication terminal in advance. In this case, although the master communication terminal does not receive the image, an exemplary embodiment of the present invention can be implemented. In other words, the master communication terminal may transmit the image to the slave communication terminals before splitting the image. The master communication terminal may transmit a certain image displaying time point to the slave communication terminals. Moreover, although cases when the master communication terminal is connected to the slave communication terminals through Bluetooth communication have been described in the above-mentioned exemplary embodiments, the present invention is not limited to these cases. The master communication terminal and the slave communication terminals may be interconnected through other short range communication other than the Bluetooth communication so that an exemplary embodiment of the present invention can be implemented.

When it is determined that the image must not be displayed in step 619, the control unit 540 may perform a corresponding function in step 623. In other words, the control unit 540 may perform Bluetooth communication with the slave communication terminals 120.

Finally, when there is a request for finishing the image processing procedure, the control unit 540 detects the request in step 625 and finishes the image processing procedure. Meanwhile, when there is no request for finishing the image processing procedure, the control unit 540 returns to step 619. Thus, users of the communication terminals can acquire a three-dimensional image with an enlarged size greater than the image displayed in a single communication terminal. Furthermore, users of the communication terminals can perceive a function executed between the communication terminals from the displayed three-dimensional image.

While the present invention has been shown and with reference to certain exemplary embodiments thereof, it should be understood by those skilled in the art that many changes in form and details may be made therein without departing from the spirit and scope of the present invention as defined in the appended claims and their equivalents.

What is claimed is:

1. An image processing method of an image processing system comprising a master communication terminal and one or more slave communication terminals, the method comprising:
splitting, by the master communication terminal, an image into a master displaying region and one or more slave displaying regions;
transmitting, by the master communication terminal, the one or more slave displaying regions to the one or more slave communication terminals; and
displaying the master displaying region and the slave displaying regions by the master communication terminal and the one or more slave communication terminals at the same time point.

2. The method of claim 1, wherein the image comprises at least one of a two-dimensional image and a three-dimensional image.

3. The method of claim 1, further comprising expanding the master displaying region by a preset multiple by the master communication terminal.

4. The method of claim 3, further comprising expanding the one or more slave displaying regions by a preset multiple by the master communication terminal.

5. The method of claim 3, further comprising expanding each of the one or more slave displaying regions by a preset multiple by each of the one or more slave communication terminals when the one or more slave displaying regions are received.

6. The method of claim 3, wherein the preset multiple corresponds to a sum of the numbers of the master displaying region and the one or more slave displaying regions.

7. The method of claim 3, wherein the splitting of the image is performed when the image is received.

8. The method of claim 1, wherein the master communication terminal and the one or more slave communication terminals are interconnected through a Peer-to-Peer (P2P) connection.

9. The method of claim 8, wherein the P2P connection is established through at least one of Bluetooth communication and Infrared Data Association (IrDA) communication.

10. An image processing method of an image processing system comprising a master communication terminal and one or more slave communication terminal, the method comprising:
assigning, by the master communication terminal, a portion of a master displaying region and one or more slave displaying regions of the image when displaying the image, and transmitting the portion of the respective one or more slave displaying regions to the respective one or more slave communication terminals by the master communication terminal;
splitting the image into the master displaying region and the one or more slave displaying regions by the master communication terminal and the one or more slave communication terminals;
expanding, by the master communication terminal, the portion of the master displaying region by a preset multiple, and expanding, by the respective one or more slave communication terminals, the transmitted portion of the one or more slave displaying regions by a preset multiple; and
displaying the master displaying region and the one or more slave displaying regions by the master communication terminal and the one or more slave communication terminals at the same time point.

11. The method of claim 10, wherein the image comprises at least one of a two-dimensional image and a three-dimensional image.

12. The method of claim 10, wherein the preset multiple corresponds to sum of the numbers of the master displaying region and the one or more slave displaying regions.

13. The method of claim 12, wherein the splitting of the image is performed when the image is received.

14. The method of claim 12, further comprising transmitting the image to the one or more slave communication terminals by the master communication terminal.

15. The method of claim 14, wherein the transmission of the image is performed when the image is received.

16. The method of claim 10, wherein the master communication terminal and the one or more slave communication terminals are interconnected through a Peer-to-Peer (P2P) connection.

17. The method of claim 16, wherein the P2P connection is established through at least one of Bluetooth communication and Infrared Data Association (IrDA) communication.

18. An image processing system, the system comprising:
a master communication terminal for assigning a master displaying region and one or more slave displaying regions of an image when displaying the image, for splitting the image into the master displaying region and the one or more slave displaying regions, and for displaying the master displaying region; and
at least one slave communication terminal for displaying any one of the one or more slave displaying regions when the master communication terminal displays the master displaying region.

19. The system of claim 18, wherein the image comprises at least one of a two-dimensional image and a three-dimensional image.

20. The system of claim 18, wherein the master communication terminal informs the one or more slave communication terminals of a respective portion of the one or more slave displaying regions and each of the one or more slave communication terminals displays the slave displaying region corresponding to the informed portion.

21. The system of claim 20, wherein the master communication terminal displays the master displaying region by expanding the master displaying region by a preset multiple.

22. The system of claim 21, wherein the preset multiple is calculated and registered in advance.

23. The system of claim 21, wherein the master communication terminal expands the respective one or more slave displaying regions by the preset multiple and transmits the expanded one or more slave displaying regions to the respective one or more slave communication terminals.

24. The system of claim 21, wherein each of the one or more slave communication terminals displays the corresponding slave displaying region of the assigned portion by expanding the corresponding slave displaying region by the preset multiple.

25. The system of claim 21, wherein the preset multiple corresponds to sum of the numbers of the master displaying region and the one or more slave displaying regions.

26. The system of claim 21, wherein the master communication terminal transmits the respective one or more slave displaying regions to the respective one or more slave communication terminals.

27. The system of claim 24, wherein each of the one or more slave communication terminals splits the image into the master displaying region and the one or more slave displaying regions.

28. The system of claim 18, wherein the master communication terminal and the one or more slave communication terminals are interconnected through a Peer-to-Peer (P2P) connection.

29. The system of claim 28, wherein the P2P connection is established through at least one of Bluetooth communication and Infrared Data Association (IrDA) communication.
